(19) United States
(12) Patent Application Publication
(10) Pub. No.: US 2012/0300035 A1
(43) Pub. Date: Nov. 29, 2012

(54) ELECTRONIC CAMERA

(75) Inventor: Masayoshi Okamoto, Daito-shi (JP)

(73) Assignee: SANYO ELECTRIC CO., LTD., Osaka (JP)

(21) Appl. No.: 13/463,297

(22) Filed: May 3, 2012

(30) Foreign Application Priority Data
May 26, 2011 (JP) 2011-117783

(51) Int. Cl. H04N 13/02

(52) U.S. Cl. 348/46

(57) ABSTRACT

An electronic camera includes an imager. An imager captures a scene through an optical system. A distance adjuster adjusts an object distance to a designated distance. A depth adjuster adjusts a depth of field to a predetermined depth, corresponding to completion of an adjustment of the distance adjuster. An acceptor accepts a changing operation for changing a length of the designated distance. A changer changes the depth of field to an enlarged depth greater than the predetermined depth, in response to the changing operation.

### CROSS REFERENCE OF RELATED APPLICATION

The disclosure of Japanese Patent Application No. 2011-117783, which was filed on May 26, 2011, is incorporated herein by reference.

### BACKGROUND OF THE INVENTION

1. Field of the Invention

The present invention relates to an electronic camera, and in particular, relates to an electronic camera which adjusts an object distance to a designated distance.

2. Description of the Related Art

According to one example of this type of camera, a face information detecting circuit detects face information of an object from image data acquired by an imaging element. An object distance estimating section estimates an object distance based on the detected face information of the object. An autofocus control section controls an autofocus based on the object distance estimated by the object distance estimating section.

However, in the above-described camera, since the object distance is estimated based on the face information and the autofocus is controlled based on the estimated object distance, an image becomes more blurred when the object distance is drastically changed, and therefore, a quality of the image may be deteriorated.

### SUMMARY OF THE INVENTION

An electronic camera according to the present invention comprises: an imager which captures a scene through an optical system; a distance adjuster which adjusts an object distance to a designated distance; a depth adjuster which adjusts a depth of field to a predetermined depth, corresponding to completion of an adjustment of the distance adjuster; an acceptor which accepts a changing operation for changing a length of the designated distance; and a changer which changes the depth of field to an enlarged depth greater than the predetermined depth, in response to the changing operation.

According to the present invention, an imaging control program recorded on a non-transitory recording medium in order to control an electronic camera provided with an imager which captures a scene through an optical system, the program causing a processor of the electronic camera to perform the steps comprises: a distance adjusting step of adjusting an object distance to a designated distance; a depth adjusting step of adjusting a depth of field to a predetermined depth, corresponding to completion of an adjustment of the distance adjusting step; an accepting step of accepting a changing operation for changing a length of the designated distance; and a changing step of changing the depth of field to an enlarged depth greater than the predetermined depth, in response to the changing operation.

According to the present invention, an imaging control method executed by an electronic camera provided with an imager which captures a scene through an optical system, comprises: a distance adjusting step of adjusting an object distance to a designated distance; a depth adjusting step of adjusting a depth of field to a predetermined depth, corresponding to completion of an adjustment of the distance adjusting step; an accepting step of accepting a changing operation for changing a length of the designated distance; and a changing step of changing the depth of field to an enlarged depth greater than the predetermined depth, in response to the changing operation.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an SDRAM applied to the embodiment in FIG. 2;

FIG. 4 is an illustrative view showing one example of an assignment state of an evaluation area in an imaging surface;

FIG. 5 is an illustrative view showing one example of a face-detection frame structure used in a face detecting process;

FIG. 6 is an illustrative view showing one example of a configuration of a face dictionary referred to in the face detecting process;

FIG. 7 is an illustrative view showing one portion of the face detecting process;

FIG. 8 is an illustrative view showing one example of a configuration of a register referred to in the embodiment in FIG. 2;

FIG. 9 is an illustrative view showing one example of a configuration of another register referred to in the embodiment in FIG. 2;

FIG. 10(A) is an illustrative view showing another example of the face-detection frame structure used in the face detecting process;

FIG. 10(B) is an illustrative view showing one example of a predetermined range around a main face image;

FIG. 11 is an illustrative view showing one example of a configuration of a table referred to in the embodiment in FIG. 2;

FIG. 12(A) is an illustrative view showing one example of a view of an LCD monitor;

FIG. 12(B) is an illustrative view showing one portion of a specific AF process;

FIG. 13(A) is an illustrative view showing another example of the view of the LCD monitor;

FIG. 13(B) is an illustrative view showing another portion of the specific AF process;

FIG. 14(A) is an illustrative view showing still another example of the view of the LCD monitor;

FIG. 14(B) is an illustrative view showing still another portion of the specific AF process;

FIG. 15(A) is an illustrative view showing yet another example of the view of the LCD monitor;

FIG. 15(B) is an illustrative view showing yet another portion of the specific AF process;

FIG. 16(A) is an illustrative view showing another example of the view of the LCD monitor;

FIG. 16(B) is an illustrative view showing another portion of the specific AF process;

FIG. 17 is a flowchart showing one portion of behavior of a CPU applied to the embodiment in FIG. 2;

FIG. 18 is a flowchart showing another portion of behavior of the CPU applied to the embodiment in FIG. 2;

FIG. 19 is a flowchart showing still another portion of behavior of the CPU applied to the embodiment in FIG. 2;

FIG. 20 is a flowchart showing yet another portion of behavior of the CPU applied to the embodiment in FIG. 2;

FIG. 21 is a flowchart showing another portion of behavior of the CPU applied to the embodiment in FIG. 2;

FIG. 22 is a flowchart showing still another portion of behavior of the CPU applied to the embodiment in FIG. 2;

FIG. 23 is a flowchart showing yet another portion of behavior of the CPU applied to the embodiment in FIG. 2;

FIG. 24 is a flowchart showing another portion of behavior of the CPU applied to the embodiment in FIG. 2;

FIG. 25 is a flowchart showing one portion of behavior of the CPU applied to another embodiment of the present invention; and

FIG. 26 is a block diagram showing a configuration of another embodiment of the present invention.

### DETAILED DESCRIPTION OF THE PREFERRED EMBODIMENTS

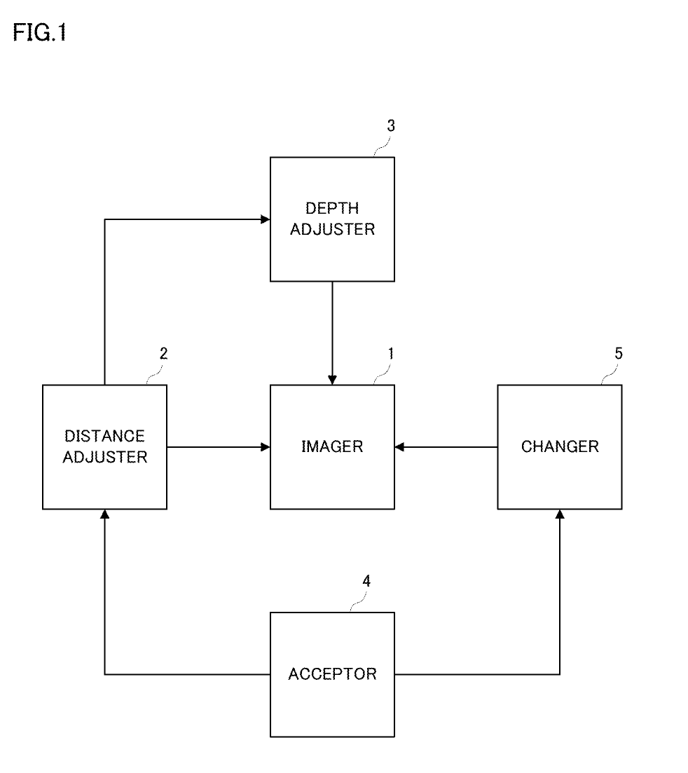

With reference to FIG. 1, an electronic camera according to one embodiment of the present invention is basically configured as follows: An imager 1 captures a scene through an optical system. A distance adjuster 2 adjusts an object distance to a designated distance. A depth adjuster 3 adjusts a depth of field to a predetermined depth, corresponding to completion of an adjustment of the distance adjuster 2. An acceptor 4 accepts a changing operation for changing a length of the designated distance. A changer 5 changes the depth of field to an enlarged depth greater than the predetermined depth, in response to the changing operation.

In response to the operation for changing the designated magnitude of the object distance, the depth of field is changed to the enlarged depth greater than the predetermined depth. That is, the depth of field is set to the depth greater than before adjusting the object distance.

Accordingly, even when the object distance is drastically changed, it becomes possible to improve a quality of an image outputted from the imager 1 by reducing a blur associated with changing the object distance.

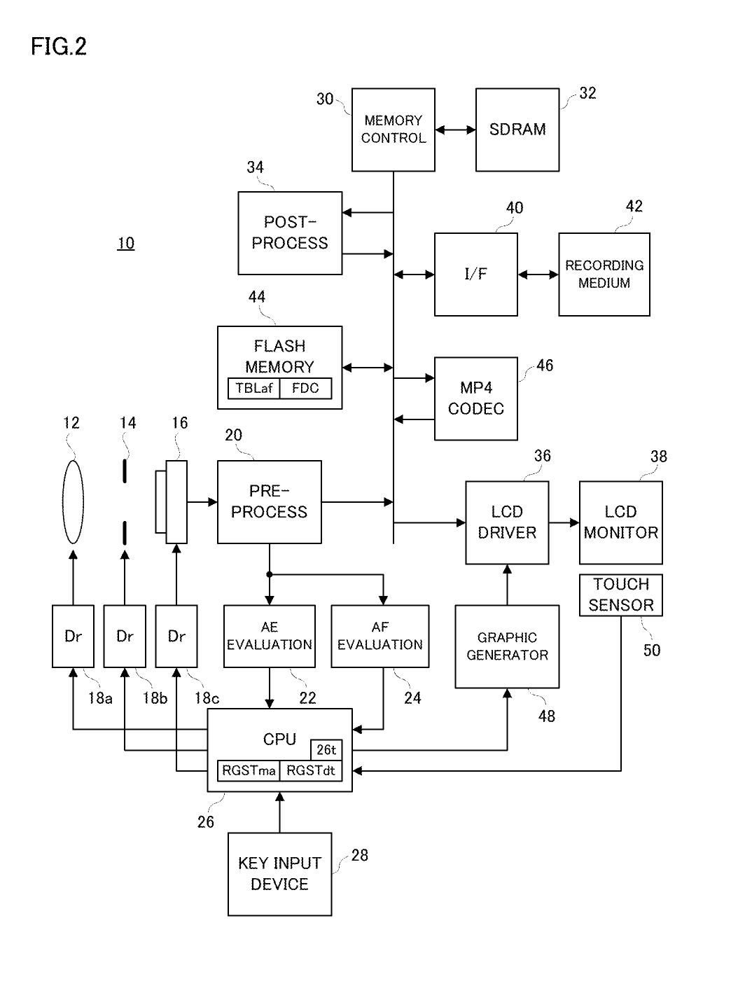

With reference to FIG. 2, a digital video camera 10 according to one embodiment includes a focus lens 12 and an aperture unit 14 driven by drivers 18a and 18b, respectively. An optical image of a scene that underwent these components enters, with irradiation, an imaging surface of an image sensor 16, and is subjected to a photoelectric conversion.

When a power source is applied, in order to execute a moving-image taking process, a CPU 26 commands a driver 18c to repeat an exposure procedure and an electric-charge reading-out procedure under an imaging task. In response to a vertical synchronization signal Vsync periodically generated from an SG (Signal Generator) not shown, the driver 18c exposes the imaging surface of the image sensor 16 and reads out the electric charges produced on the imaging surface of the image sensor 16 in a raster scanning manner. From the image sensor 16, raw image data that is based on the read-out electric charges is cyclically outputted.

A pre-processing circuit 20 performs processes, such as digital clamp, pixel defect correction, gain control and etc., on the raw image data outputted from the image sensor 16. The raw image data on which these processes are performed is written into a raw image area 32a of an SDRAM 32 through a memory control circuit 30.

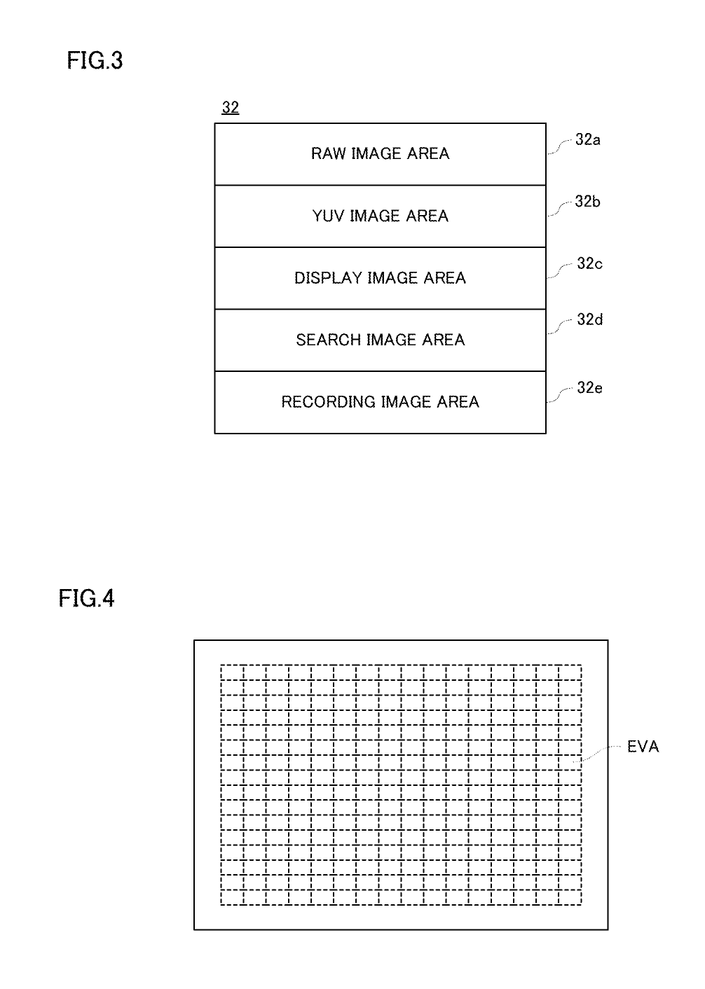

A post-processing circuit 34 reads out the raw image data stored in the raw image area 32a through the memory control circuit 30, and performs a color separation process, a white balance adjusting process and a YUV converting process, on the read-out raw image data. The YUV formatted image data produced thereby is written into a YUV image area 32b of the SDRAM 32 through the memory control circuit 30 (see FIG. 3).

Furthermore, the post-processing circuit 34 executes a zoom process for display and a zoom process for search to the image data that comply with a YUV format, in a parallel manner. As a result, display image data and search image data that comply with the YUV format is individually created. The display image data is written into a display image area 32c of the SDRAM 32 by the memory control circuit 30 (see FIG. 3). The search image data is written into a search image area 32d of the SDRAM 32 by the memory control circuit 30 (see FIG. 3).

An LCD driver 36 repeatedly reads out the display image data stored in the display image area 32c through the memory control circuit 30, and drives an LCD monitor 38 based on the read-out image data. As a result, a real-time moving image (a live view image) representing the scene is displayed on the LCD monitor 38.

With reference to FIG. 4, an evaluation area EVA is assigned to a center of the imaging surface of the image sensor 16. The evaluation area EVA is divided into 16 portions in each of a horizontal direction and a vertical direction; therefore, 256 divided areas form the evaluation area EVA. Moreover, in addition to the above-described processes, the pre-processing circuit 20 shown in FIG. 2 executes a simple RGB converting process which simply converts the raw image data into RGB data.

An AE evaluating circuit 22 integrates RGB data belonging to the evaluation area EVA, out of the RGB data produced by the pre-processing circuit 20, at every time the vertical synchronization signal Vsync is generated. Thereby, 256 integral values (256 AE evaluation values) are outputted from the AE evaluating circuit 22 in response to the vertical synchronization signal Vsync. An AF evaluating circuit 24 integrates a high-frequency component of the RGB data belonging to the evaluation area EVA, out of the RGB data generated by the pre-processing circuit 20, at every time the vertical synchronization signal Vsync is generated. Thereby, 256 integral values (256 AF evaluation values) are outputted from the AF evaluating circuit 24 in response to the vertical synchronization signal Vsync. Processes based on thus acquired AE evaluation values and the AF evaluation values will be described later.

When a recording start operation is performed on a key input device 28, the CPU 26 activates an MP4 codec 46 and an OF 40 under the imaging task in order to start a recording process. The MP4 codec 46 reads out the image data stored in the YUV image area 32b through the memory control circuit 30, and compresses the read-out image data according to the MPEG4 format. The compressed image data, i.e., MP4 data is written into a recording image area 32e by the memory control circuit 30 (see FIG. 3). The OF 40 reads out the MP4 data stored in the recording image area 32e through the memory control circuit 30, and writes the read-out MP4 data into an image file created in a recording medium 42.

When a recording end operation is performed on a key input device 28, the CPU 26 stops the MP4 codec 46 and the OF 40 in order to end the recording process.

The CPU 26 sets a flag FLG_f to “0” as an initial setting under a face detecting task executed in parallel with the imaging task. Subsequently, the CPU 26 executes a face detecting process in order to search for a face image of a person from the search image data stored in the search image area 32d, at every time the vertical synchronization signal Vsync is generated.

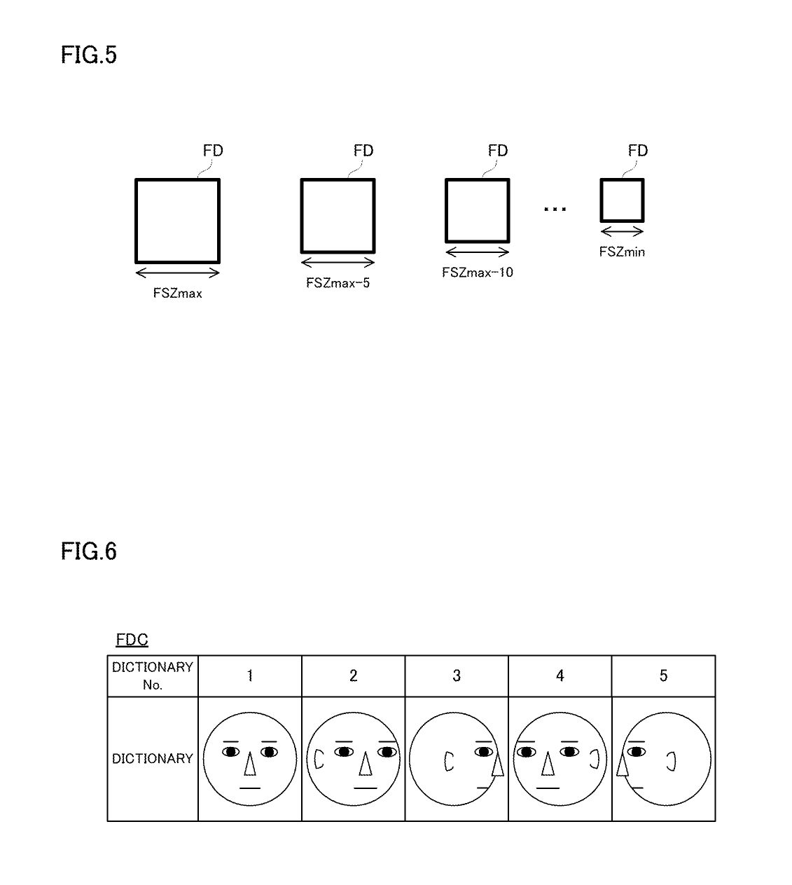

In the face detecting process, used are a face-detection frame structure FD of which size is adjusted as shown in FIG. 5 and a face dictionary FDC containing five dictionary images (=face images of which directions are mutually different) shown in FIG. 6. It is noted that the face dictionary FDC is stored in a flash memory 44.

In the face detecting process, firstly, the whole evaluation area EVA is set as a search area. Moreover, in order to define a variable range of the size of the face-detection frame structure FD, a maximum size FSZmax is set to “200”, and a minimum size FSZmin is set to “20”.

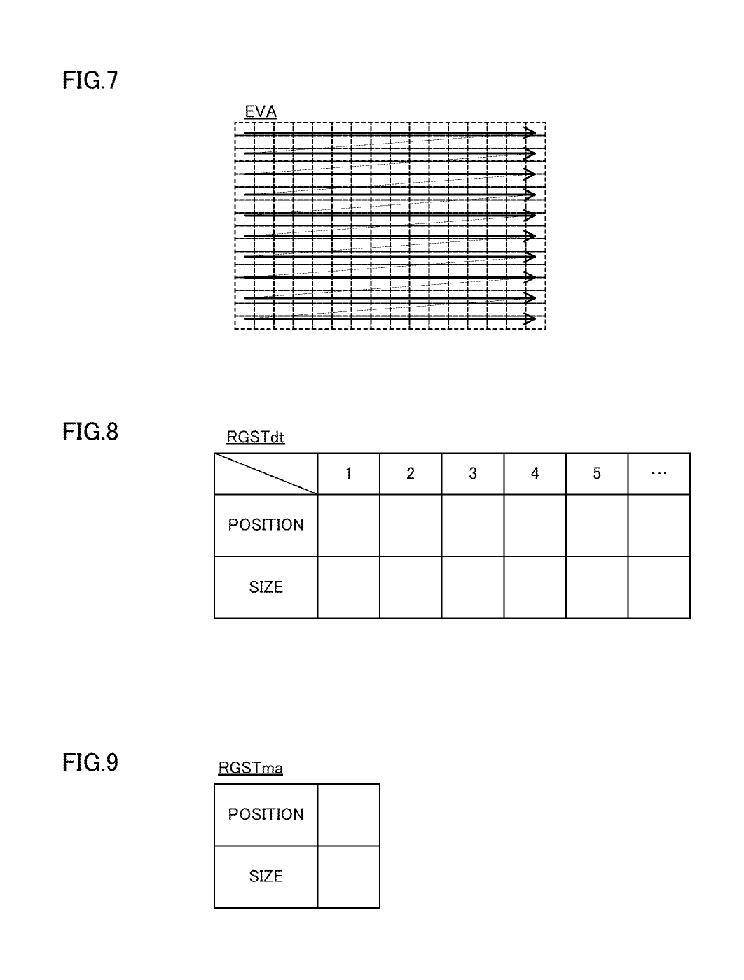

The face-detection frame structure FD is moved by each predetermined amount in the raster scanning manner, from a start position (an upper left position) toward an ending position (a lower right position) of the search area (see FIG. 7). Moreover, the size of the face-detection frame structure FD is reduced by a scale of “5” from “FSZmax” to “FSZmin” at every time the face-detection frame structure FD reaches the ending position.

Partial search image data belonging to the face-detection frame structure FD is read out from the search image area 32d through the memory control circuit 30. A characteristic amount of the read-out search image data is compared with a characteristic amount of each of the five dictionary images contained in the face dictionary FDC. When a matching degree equal to or more than a threshold value TH is obtained, it is regarded that the face image has been detected. A position and a size of the face-detection frame structure FD at a current time point are registered, as face information, in a face-detection register RGSTdt shown in FIG. 8. Moreover, in order to declare that a person has been discovered, the CPU 26 sets the flag FLG_f to “1”.

It is noted that, after the human-body detecting process is completed, when there is no registration of the face information in the face-detection register RGSTdt, i.e., when a face of a person has not been discovered, the CPU 26 sets the flag FLG_f to “0” in order to declare that the person is undiscovered.

When the flag FLG_f indicates “0”, under an AE/AF control task executed in parallel with the imaging task, the CPU 26 executes an AF process in which a center of the scene is noticed. The CPU 26 extracts, out of the 256 AF evaluation values outputted from the AF evaluating circuit 24, AF evaluation values corresponding to a predetermined region of the center of the scene, and executes an AF process that is based on the extracted partial AF evaluation values. As a result, the focus lens 12 is placed at a focal point in which the center of the scene is noticed, and thereby, a sharpness of a live view image or a recorded image is continuously improved.

Subsequently, the CPU 26 commands the driver 18b to adjust an aperture amount of the aperture unit 14. Thereby, the depth of field is set to “Da” which is the deepest in predetermined depths of field.

When the flag FLG_f indicates “0”, under the AE/AF control task, the CPU 26 also executes an AE process in which the whole scene is considered, based on the 256 AE evaluation values outputted from the AE evaluating circuit 22. An aperture amount and an exposure time period defining an optimal EV value calculated by the AE process are respectively set to the drivers 18b and 18c. As a result, a brightness of the live view image or the recorded image is adjusted by considering the whole scene.

When the flag FLG_f is updated to “1”, under the imaging task, the CPU 26 requests a graphic generator 48 to display a face frame structure GF with reference to a registration content of the face-detection register RGSTdt. The graphic generator 48 outputs graphic information representing the face frame structure GF toward the LCD driver 36. The face frame structure GF is displayed on the LCD monitor 38 in a manner to be adapted to the position and size of the face image detected under the face detecting task.

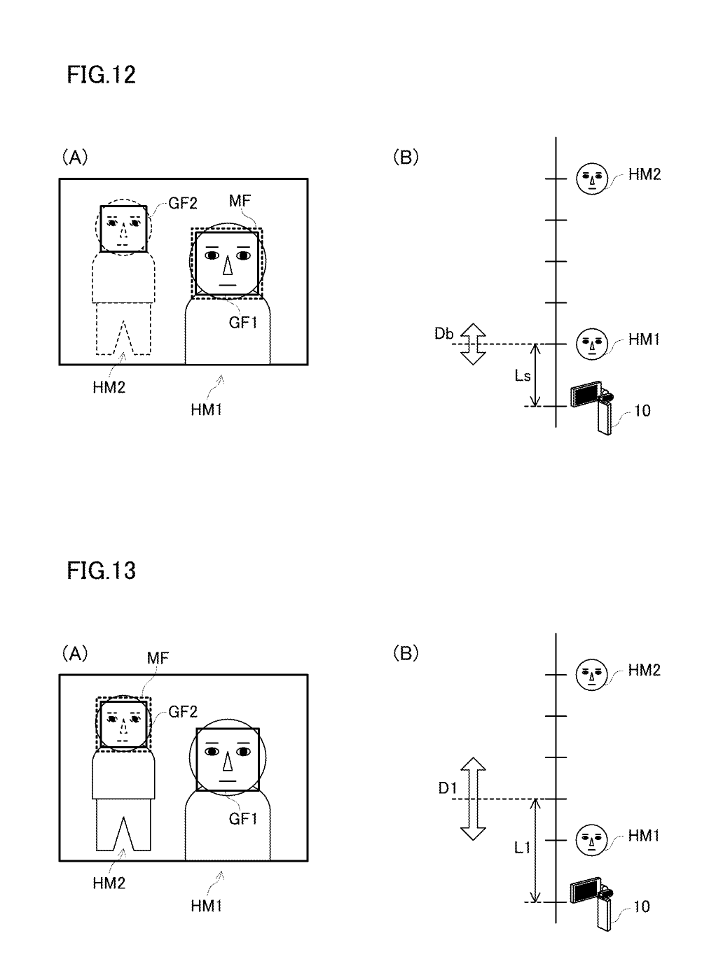

Thus, when a face of each of persons HM1 and HM2 is captured on the imaging surface, face frame structures GF1 and GF2 are displayed on the LCD monitor 38 as shown in FIG. 12 (A), in a manner to respectively surround a face image of the person HM1 and a face image of the person HM2.

Moreover, when the flag FLG_f is updated to “1”, under the AE/AF control task, the CPU 26 determines a main face image from among face images registered in the face-detection register RGSTdt. When one face image is registered in the face-detection register RGSTdt, the CPU 26 uses the registered face image as the main face image. When a plurality of face images are registered in the face-detection register RGSTdt, the CPU 26 uses a face image having a maximum size as the main face image. When a plurality of face images indicating the maximum size are registered, the CPU 26 uses, as the main face image, a face image which is the nearest to the center of the imaging surface out of the plurality of face images. A position and a size of the face image used as the main face image are registered in a main-face image register RGSTma shown in FIG. 9.

When the main face image is determined, under the AE/AF control task, the CPU 26 executes an AF process in which the main face image is noticed. The CPU 26 extracts, out of the 256 AF evaluation values outputted from the AF evaluating circuit 24, AF evaluation values corresponding to the position and size registered in the main-face image register RGSTma. The CPU 26 executes an AF process that is based on the extracted partial AF evaluation values. As a result, the focus lens 12 is placed at a focal point in which the main face image is noticed, and thereby, a sharpness of a main face image in a live view image or a recorded image is improved.

Upon completion of the AF process in which the main face image is noticed, the CPU 26 commands the driver 18b to adjust the aperture amount of the aperture unit 14. Thereby, the depth of field is set to “Db” which is the shallowest in the predetermined depths of field.

Subsequently, under the AE/AF control task, the CPU 26 extracts, out of the 256 AE evaluation values outputted from the AE evaluating circuit 22, AE evaluation values corresponding to the position and size registered in the main-face image register RGSTma. The CPU 26 executes an AE process in which the main face image is noticed, based on the extracted partial AE evaluation values. An aperture amount and an exposure time period defining an optimal EV value calculated by the AE process are respectively set to the drivers 18b and 18c. As a result, a brightness of the live view image or the recorded image is adjusted by noticing the main face image.

When the main face image is determined, under the imaging task, the CPU 26 also requests the graphic generator 48 to display a main-face frame structure MF with reference to a registration content of the main-face image register RGSTma. The graphic generator 48 outputs graphic information representing the main-face frame structure MF toward the LCD driver 36. The main-face frame structure MF is displayed on the LCD monitor 38 in a manner to be adapted to the position and size of the face image registered in the main-face image register RGSTma.

According to an example shown in FIG. 12(A), the person HM1 exists at a near side from the person HM2, and a size of the face image of the person HM1 is larger than a size of the face image of the person HM2. Thus, the face image of the person HM1 is determined as the main face image, and face information of the person HM1 is registered in the main-face image register RGSTma.

Subsequently, executed is an AF process in which the face image of the person HM1 that is the main face image is noticed, and then the depth of field is set to “Db” which is the shallowest in the predetermined depths of field. As a result, a sharpness of the face image of the person HM2 is deteriorated, whereas a sharpness of the face image of the person HM1 is improved. Moreover, executed is an AE process in which the face image of the person HM1 that is the main face image is noticed, and therefore, a brightness of the live view image or the recorded image is adjusted to a brightness suitable for the face image of the person HiM1. Furthermore, the main face frame structure MF is displayed on the LCD monitor 38 as shown in FIG. 12(A), in a manner to surround the face image of the person HM1.

When the main face image is registered in the main-face image register RGSTma, it is determined whether or not there exists the face image in a predetermined range AR on a periphery of the main face image, with reference to the face-detection register RGSTdt. The predetermined range AR on the periphery of the main face image is obtained in a following manner.

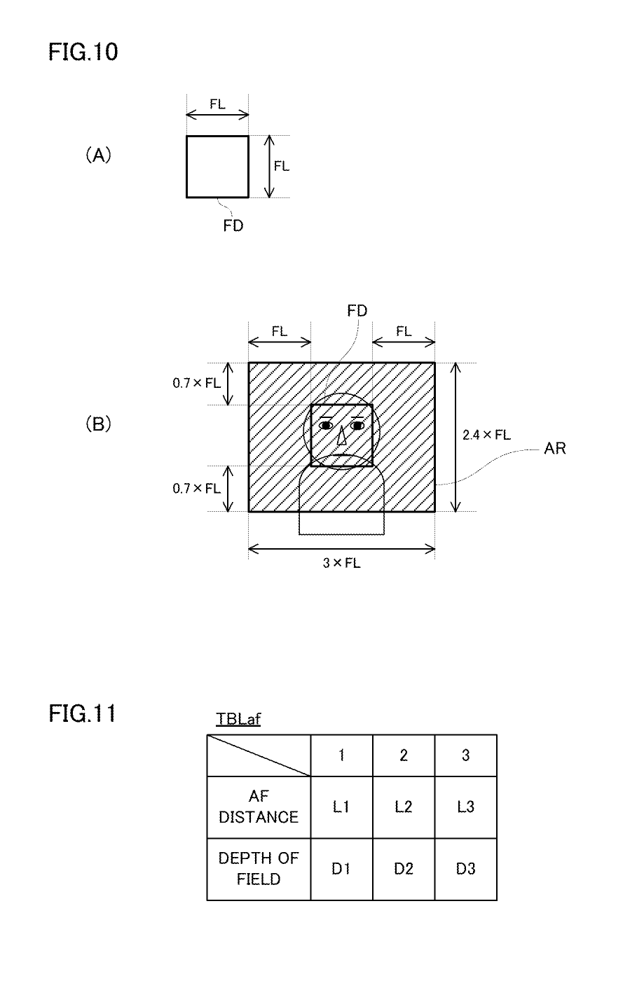

The size described in the main-face image register RGSTma indicates the size of the face-detection frame structure FD at a time of detecting the face image. With reference to FIG. 10(B), when a length of the face-detection frame structure FD is set to “FL” on a side as shown in FIG. 10(A), it is possible to use the predetermined range AR on the periphery of the main face image as a rectangular range centering a main face image having a vertical length of “2.4×FL” and a horizontal length of “3×FL”, for example. It is noted that, other ranges may be the predetermined range AR.

When there exists the face image on the periphery of the main face image, it is determined that the face image indicates the main face image after moving, and a description of the main-face image register RGSTma is updated. When there does not exist the face image on the periphery of the main face image, under the AE/AF control task, the CPU 26 determines again the main face image from among face images registered in the face-detection register RGSTdt. Moreover, when the flag FLG_f is updated from “1” to “0”, the registration content of the main-face image register RGSTma is cleared.

When a touch operation is performed on the LCD monitor 38 in a state where the live view image is displayed on the LCD monitor 38, a touch position is detected by a touch sensor 50, and therefore, a detected result is applied to the CPU 26.

When any of the face images except the main face image out of one or at least two face images registered in the face-detection register RGSTdt is coincident with the touch position, it is regarded that a face image of the touch position is designated by an operator as the main face image. Thus, the CPU 26 updates the description of the main-face image register RGSTma to face information of the designated face image. When the main face image is updated by the touch operation, the CPU 26 executes a specific AF process in which the updated main face image is noticed. The specific AF process is executed in a following manner.

The CPU 26 calculates a criterion distance of a current AF process (hereafter, “AF distance”) as “Ls”. Since the immediately preceding AF process is executed by noticing the main face image before updated, the AF distance Ls is equivalent to a distance between the digital video camera 10 and a person of the main face image before updated. Moreover, the AF distance Ls is capable of being calculated based on a current position of the focus lens 12.

Subsequently, the CPU26 reads out a size of the updated main face image from the main-face image register RGSTma. The size of the updated main face image is inversely proportional to a distance between the digital video camera 10 and a person of the updated main face image. That is, the longer the distance becomes, the smaller the size becomes. On the other hand, the shorter the distance becomes, the larger the size becomes. Based on the size of the updated main face image, the CPU 26 calculates a target AF distance Le which is equivalent to the distance between the digital video camera 10 and the person of the updated main face image.

In the specific AF process, the CPU 26 executes changing the AF distance from the current AF distance Ls to the target AF distance Le (moving the focus lens 12) in four steps. The AF distance is changed in order of “L1”, “L2”, “L3” and “Le”. Moreover, the CPU 26 changes the depth of filed at every time the AF distance is changed one level (=adjusting the aperture amount of the aperture unit 14). The depth of field is changed in order of “D1”, “D2”, “D3”, and “Db”.

The AF distance L1 is obtained by Equation 1 indicated below, based on the current AF distance Ls and the target AF distance Le.

$$L 1 = Ls + \frac{Le - Ls}{4} \qquad [ Equation 1 ]$$

The depth of field D1 is obtained by Equation 2 indicated below, based on the current AF distance Ls, the target AF distance Le and the depth of field Db.

$$D 1 = Db + \frac{\vert Le - Ls \vert}{2} \qquad [ Equation 2 ]$$

The AF distance L2 is obtained by Equation 3 indicated below, based on the current AF distance Ls and the target AF distance Le.

$$L 2 = Ls + \frac{Le - Ls}{4} * 2 \qquad [ Equation 3 ]$$

The depth of field D2 is obtained by Equation 4 indicated below, based on the current AF distance Ls, the target AF distance Le and the depth of field Db.

D2=Db+|Le−Ls| [Equation 4]

The AF distance L3 is obtained by Equation 5 indicated below, based on the current AF distance Ls and the target AF distance Le.

$$L 3 = Ls + \frac{Le - Ls}{4} * 3 \qquad [ Equation 5 ]$$

The depth of field D3 is obtained by Equation 6 indicated below, based on the current AF distance Ls, the target AF distance Le and the depth of field Db.

$$D 3 = Db + \frac{\vert Le - Ls \vert}{2} \qquad [ Equation 6 ]$$

Each of the AF distances L1, L2 and L3 and the depths of field D1, D2 and D3 thus obtained is set to a specific AF table TBL. It is noted that the depth of field D3 is equal to the depth of field D1.

Here, the specific AF table TBL is equivalent to a table in which a changed value of the AF distance and a changed value of the depth of field in each step of the specific AF process are described. The specific AF table TBL is configured as shown in FIG. 11, for example. It is noted that the specific AF is stored in the flash memory 44.

With reference to FIG. 12(B), when the face of the each of the persons HM1 and HM2 is captured on the imaging surface as shown in FIG. 12(A), as described above, the AF distance is set to “Ls”, and the depth of field is set to “Db”. At this time, since the face image of the person HM1 is used as the main face image, as described above, the main-face frame structure MF is displayed on the LCD monitor 38 in a manner to surround the face image of the person HM1.

With reference to FIG. 13(A), when the main face image is updated to the face image of the person HM2 by the touch operation in this state, the main-face frame structure MF is displayed on the LCD monitor 38 in a manner to surround the face image of the person HM2. Moreover, when the main face image is updated, the CPU 26 executes the specific AF process. In the specific AF process, the CPU 26 moves the focus lens 12 so as to set the AF distance to “L1” longer than “Ls” with reference to the specific AF table (see FIG. 13(B)). Moreover, the CPU 26 adjusts the aperture amount of the aperture unit 14 so as to set the depth of field to “L1” deeper than “Db” (see FIG. 13(B)).

As a result, with reference to FIG. 13(A), the AF distance is changed to “L1” longer than “Ls” using the person HM1 as a reference, whereas the depth of field is changed to “D1” deeper than “Db”, and therefore, a sharpness of the face image of the person HM1 is not drastically deteriorated.

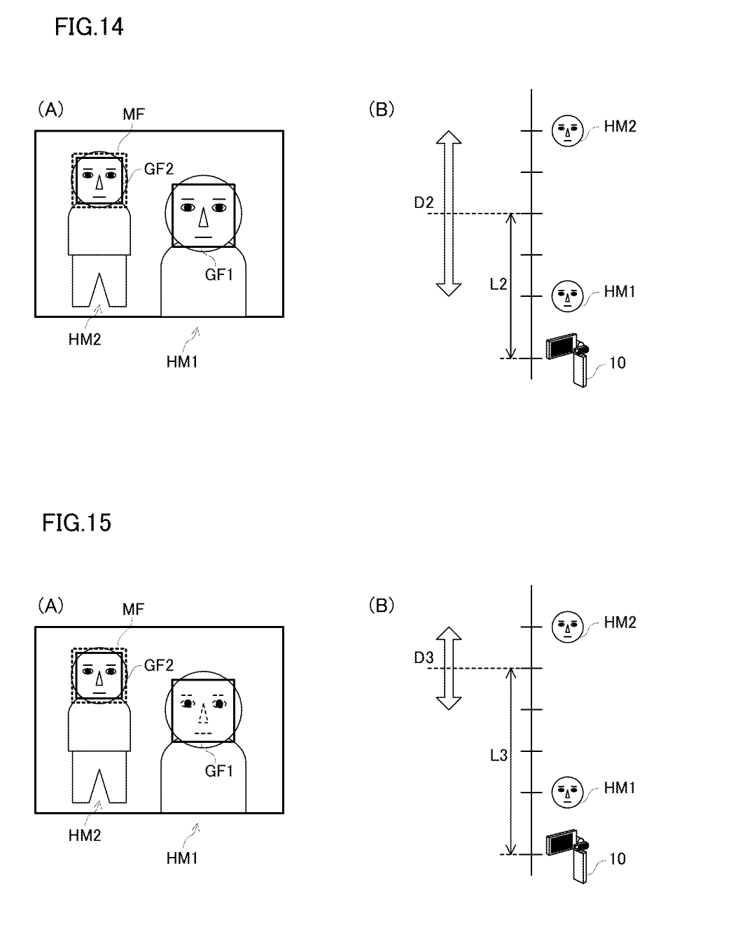

Subsequently, the CPU 26 moves the focus lens 12 so as to set the AF distance to “L2” longer than “L1” with reference to the specific AF table (see FIG. 14(B)). Moreover, the CPU 26 adjusts the aperture amount of the aperture unit 14 so as to set the depth of field to “D2” deeper than “D1” (see FIG. 14(B)).

As a result, with reference to FIG. 14(A), the AF distance is changed to “L2” longer than “L1”, whereas the depth of field is changed to “D2” deeper than “D1”, and therefore, a sharpness of the face image of the person HM1 is not drastically deteriorated. Moreover, since the AF distance is changed to “L2” close to “Le” using the person HM2 as a reference, and the depth of field is changed to “D2” deeper than “D1”. As a result, a sharpness of the face image of the person HM2 is improved.

Subsequently, the CPU 26 moves the focus lens 12 so as to set the AF distance to “L3” longer than “L2” with reference to the specific AF table (see FIG. 15(B)). Moreover, the CPU 26 adjusts the aperture amount of the aperture unit 14 so as to set the depth of field to “D3” shallower than “D2” (see FIG. 15(B)).

As a result, with reference to FIG. 15(A), a sharpness of the face image of the person HM1 is deteriorated, whereas a sharpness of the face image of the person HM2 is improved.

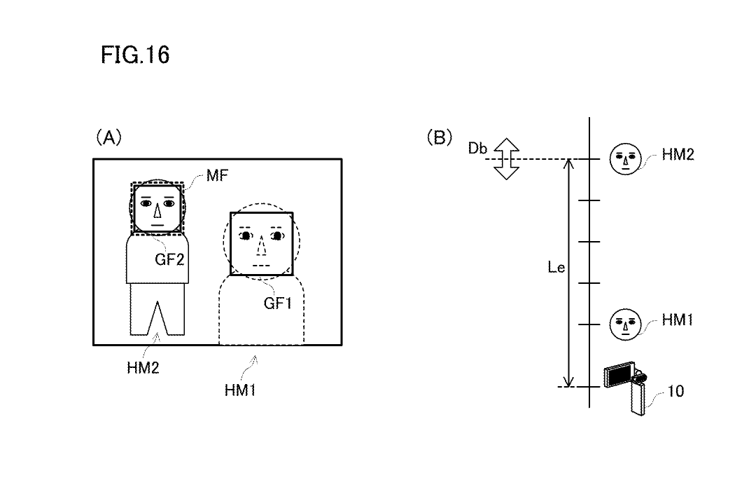

Subsequently, the CPU 26 moves the focus lens 12 so as to set the AF distance to the target AF distance Le (see FIG. 16(B)). Moreover, the CPU 26 adjusts the aperture amount of the aperture unit 14 so as to set the depth of field to “Db” shallower than “D3” (see FIG. 16(B)).

As a result, with reference to FIG. 16(A), a sharpness of the face image of the person HM1 is deteriorated, whereas a sharpness of the face image of the person HM2 is improved.

Upon completion of the specific AF process, under the AE/AF control task, the CPU 26 executes an AE process in which the updated main face image is noticed. As a result, a brightness of the live view image or the recorded image is adjusted to a brightness suitable for the updated main face image.

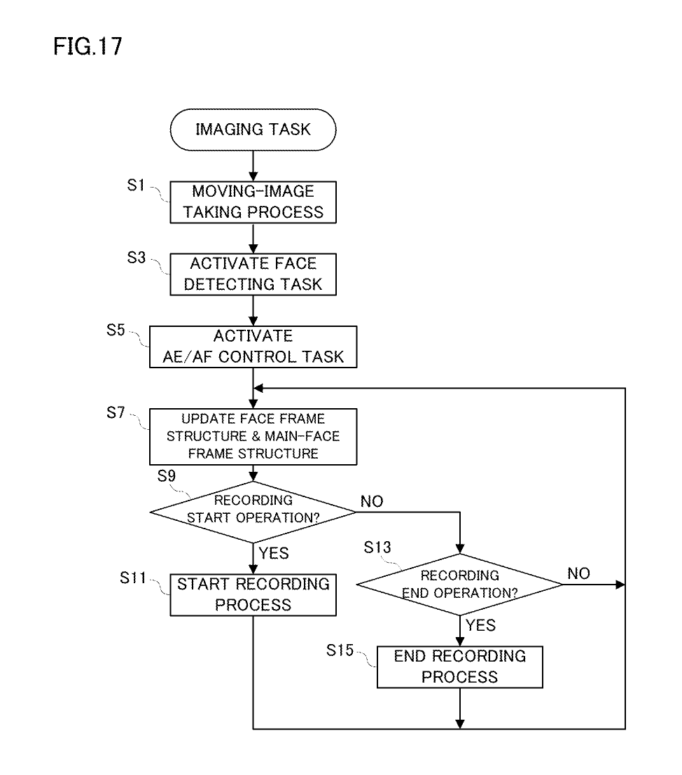

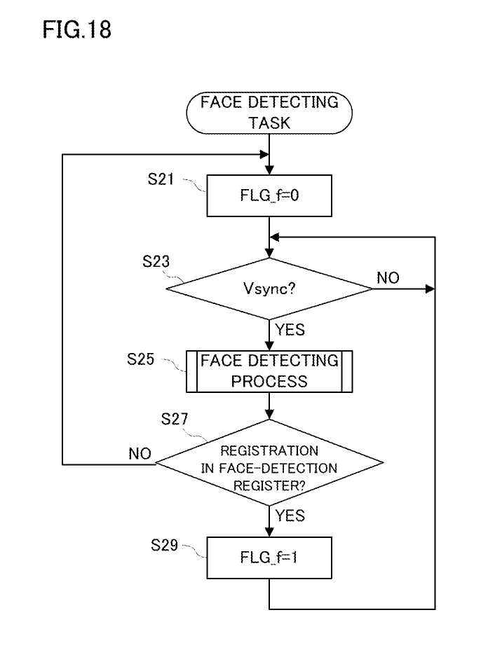

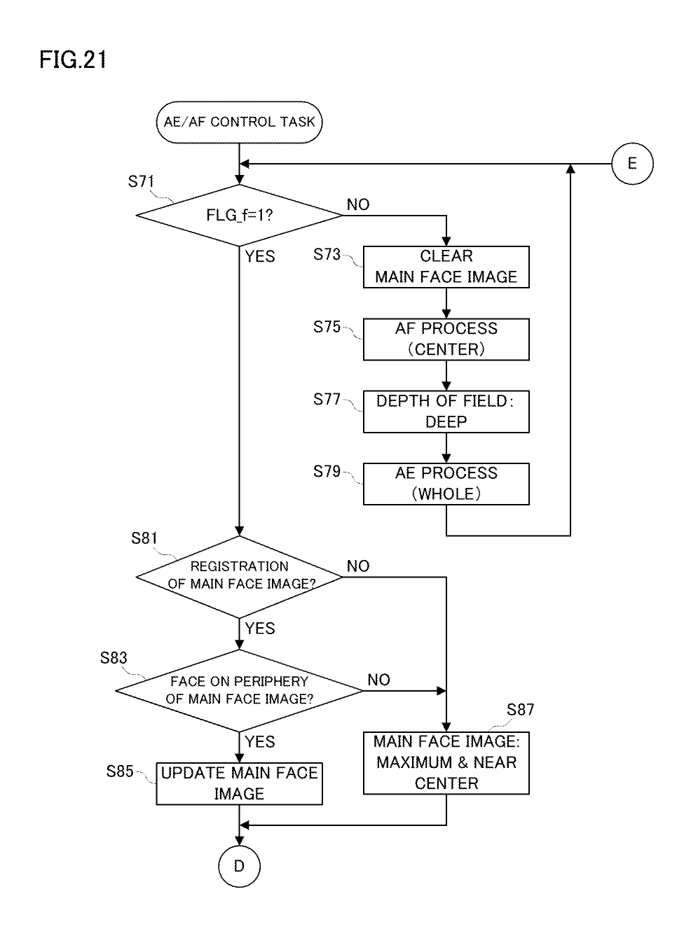

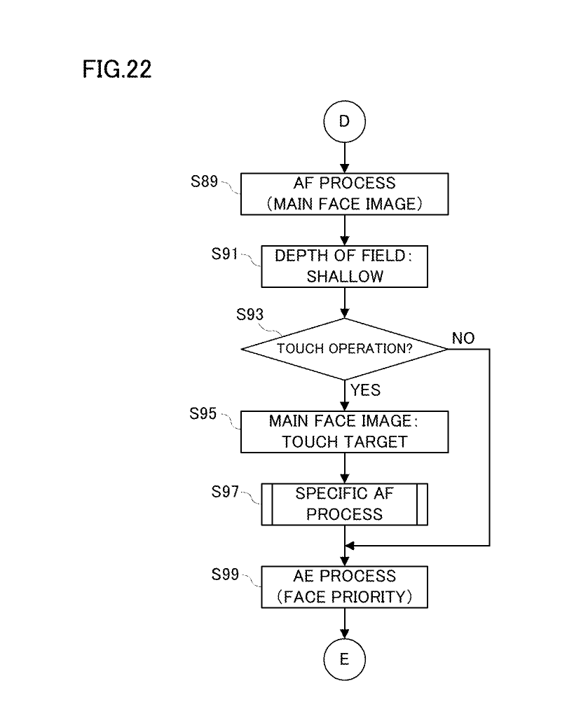

The CPU 26 executes a plurality of tasks including the imaging task shown in FIG. 17, the face detecting task shown in FIG. 18 and the AE/AF control task shown in FIG. 21 to FIG. 22, in a parallel manner. It is noted that, control programs corresponding to these tasks are stored in the flash memory 44.

With reference to FIG. 17, in a step S1, the moving image taking process is executed. As a result, a live view image representing a scene is displayed on the LCD monitor 38. In a step S3, the face detecting task is activated, and in a step S5, the AE/AF control task is activated.

In a step S7, with reference to registration contents of the face-detection register RGSTdt and the main-face image register RGSTma, each of the face frame structure GF and the main-face frame structure MF is updated to be displayed on the LCD monitor 38.

In a step S9, it is determined whether or not the recording start operation is performed on the key input device 28, and when a determined result is NO, the process advances to a step S13 whereas when the determined result is YES, in a step S11, the MP4 codec 46 and the OF 40 is activated so as to start the recording process. As a result, writing MP4 data into an image file created in the recording medium 42 is started. Upon completion of the process in the step S11, the process returns to the step S7.

In the step S13, it is determined whether or not the recording end operation is performed on the key input device 28, and when a determined result is NO, the process returns to the step S7 whereas when the determined result is YES, in a step S15, the MP4 codec 46 and the I/F 40 is stopped so as to end the recording process. As a result, writing MP4 data into the image file created in the recording medium 42 is ended. Upon completion of the process in the step S15, the process returns to the step S7.

With reference to FIG. 18, in a step S21, the flag FLG_f is set to “0” as an initial setting, and in a step S23, it is repeatedly determined whether or not the vertical synchronization signal Vsync is generated. When a determined result is updated from NO to YES, in a step S25, the face detecting process is executed.

Upon completion of the face detecting process, in a step S27, it is determined whether or not there is any registration of face information in the face-detection register RGSTdt, and when a determined result is NO, the process returns to the step S21 whereas when the determined result is YES, the process advances to a step S29.

In the step S29, the flag FLG_f is set to “1” in order to declare that a face of a person has been discovered.

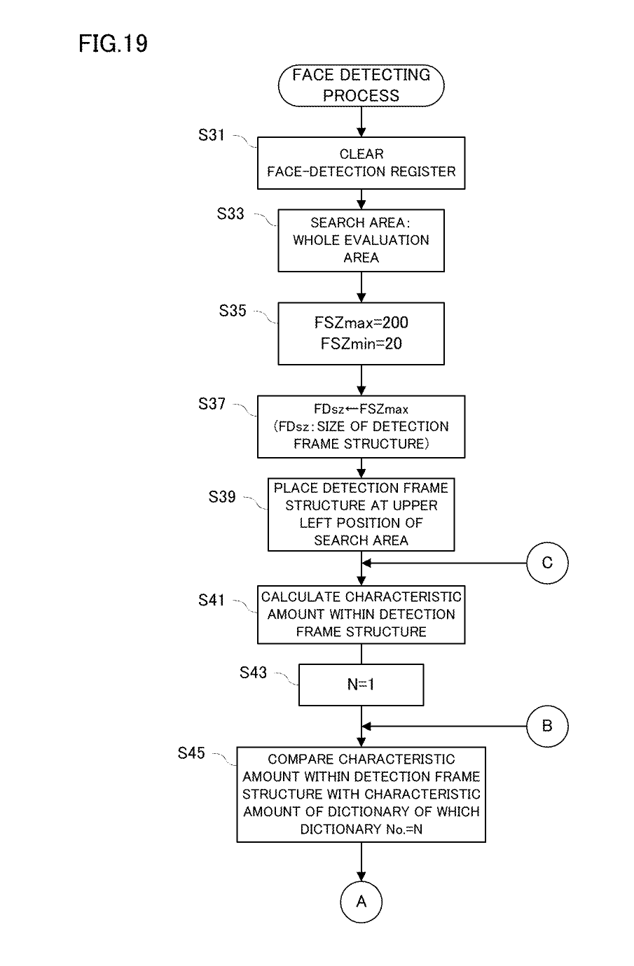

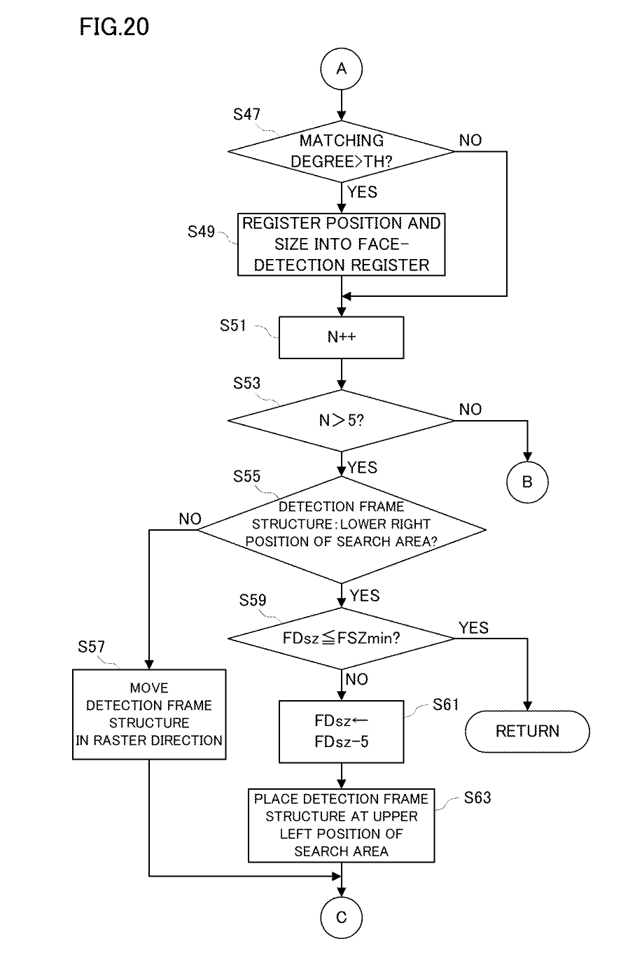

The face detecting process in the step S25 is executed according to a subroutine shown in FIG. 19 to FIG. 20. In a step S31, the registration content is cleared in order to initialize the face-detection register RGSTdt.

In a step S33, the whole evaluation area EVA is set as a search area. In a step S35, in order to define a variable range of a size of the face-detection frame structure FD, a maximum size FSZmax is set to “200”, and a minimum size FSZmin is set to “20”.

In a step S37, the size of the face-detection frame structure FD is set to “FSZmax”, and in a step S39, the face-detection frame structure FD is placed at the upper left position of the search area. In a step S41, partial search image data belonging to the face-detection frame structure FD is read out from the search image area 32d so as to calculate a characteristic amount of the read-out search image data.

In a step S43, a variable N is set to “1”, and in a step S45, the characteristic amount calculated in the step S41 is compared with a characteristic amount of the dictionary image of which a dictionary number is N, in the face dictionary FDC. As a result of comparing, in a step S47, it is determined whether or not a matching degree exceeding the threshold value TH is obtained, and when a determined result is NO, the process advances to a step S51 whereas when the determined result is YES, the process advances to the step S51 via a process in a step S49.

In the step S49, a position and a size of the face-detection frame structure FD at a current time point are registered, as face information, in the face-detection register RGSTdt.

In the step S51, the variable N is incremented, and in a step S53, it is determined whether or not the variable N has exceeded “5”. When a determined result is NO, the process returns to the step S45 whereas when the determined result is YES, in a step S55, it is determined whether or not the face-detection frame structure FD has reached the lower right position of the search area.

When a determined result of the step S55 is YES, in a step S57, the face-detection frame structure FD is moved by a predetermined amount in a raster direction, and thereafter, the process returns to the step S41. When the determined result of the step S55 is YES, in a step S59, it is determined whether or not the size of the face-detection frame structure FD is equal to or less than “FSZmin”. When a determined result of the step S59 is NO, in a step S61, the size of the face-detection frame structure FD is reduced by a scale of “5”, and in a step S63, the face-detection frame structure FD is placed at the upper left position of the search area. Thereafter, the process returns to the step S41. When the determined result of the step S59 is YES, the process returns to the routine in an upper hierarchy.

With reference to FIG. 21, in a step S71, it is determined whether or not the flag FLG_f is set to “1”, and when a determined result is YES, the process advances to a step S81 whereas when the determined result is NO, the process advances to a step S73.

In the step S73, the registration content of the main-face image register RGSTma is cleared. In a step S75, the AF process in which a center of the scene is noticed is executed. As a result, the focus lens 12 is placed at a focal point in which the center of the scene is noticed, and thereby, a sharpness of the live view image or the recorded image is continuously improved.

In a step S77, the driver 18b is commanded to adjust the aperture amount of the aperture unit 14 so as to set the depth of field to “Da” which is the deepest in predetermined depths of field.

In a step S79, the AE process in which the whole scene is considered is executed. As a result, a brightness of the live view image or the recorded image is adjusted by considering the whole scene. Upon completion of the process in the step S79, the process returns to the step S71.

In the step S81, it is determined whether or not there is any registration of the main face image in the main-face image register RGSTma, and when a determined result is NO, the process advances to a step S87 whereas when the determined result is YES, the process advances to a step S83.

In a step S83, it is determined whether or not there exists the face image in the predetermined range AR on a periphery of the main face image, with reference to the face-detection register RGSTdt. When a determined result is NO, the process advances to the step S87, whereas when the determined result is YES, in a step S85, the description of the main-face image register RGSTma is updated. Upon completion of the process in the step S85, the process advances to a step S89.

In the step S87, a face image which is the nearest to the center of the scene is determined as the main face image, out of the maximum size of face images registered in the face-detection register RGSTdt. A position and a size of the face image determined as the main face image are registered in the main-face image register RGSTma. Upon completion of the process in the step S87, the process advances to the step S89.

In the step S89, the AF process in which the main face image is noticed is executed. As a result, the focus lens 12 is placed at a focal point in which the main face image is noticed, and thereby, a sharpness of the main face image in the live view image or the recorded image is improved. In a step S91, the driver 18b is commanded to adjust the aperture amount of the aperture unit 14 so as to set the depth of field to “Db” which is the shallowest in the predetermined depths of field.

In a step S93, it is determined whether or not the touch operation is performed on any of the face images except the main face image, out of one or at least two face images displayed on the LCD monitor 38. When a determined result is NO, the process advances to a step S99, whereas when the determined result is YES, the process advances to the step S99 via processes in steps S95 and S97.

In the step S95, a face image of a touch target is determined as the main face image so as to update the description of the main-face image register RGSTma to the face image of the touch target. In the step S97, the specific AF process in which the updated main face image is noticed is executed.

In the step S99, the AE process in which the main face image is noticed is executed. As a result, a brightness of the live view image or the recorded image is adjusted by noticing the main face image. Upon completion of the process in the step S99, the process returns to the step S71.

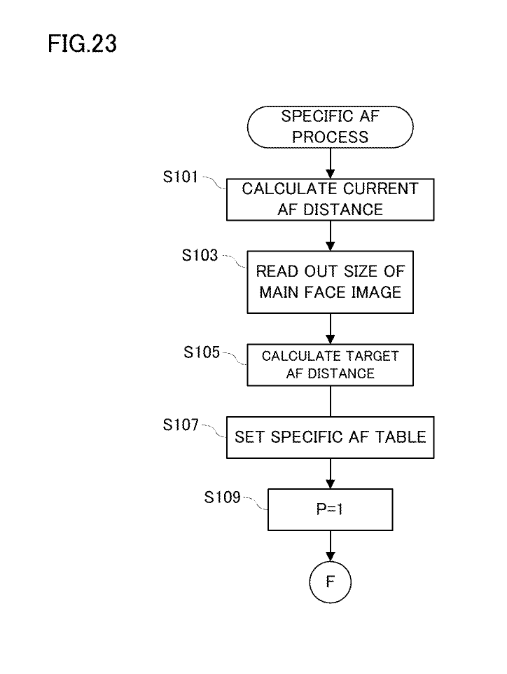

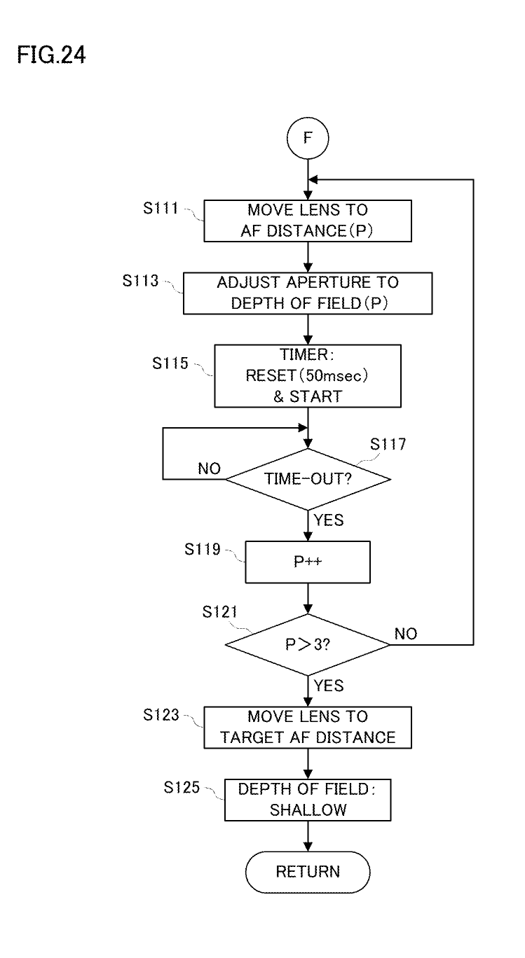

The specific AF process in the step S97 is executed according to a subroutine shown in FIG. 23 to FIG. 24. In a step S101, the current AF distance Ls is calculated with reference to a current position of the focus lens 12. In a step S103, the size of the main face image is read out from the main-face image register RGSTma, and in a step S105, the target AF distance Le is calculated.

In a step S107, each of the AF distances “L1”, “L2” and “L3” and the depths of field “D1”, “D2” and “D3” is obtained based on the current AF distance Ls, the target AF distance Le and the depth of field Db so as to set the specific AF table.

In a step S109, a variable P is set to “1”, and in a step S111, the focus lens 12 is moved based on a P-th AF distance set in the specific AF table. In a step S113, the aperture amount of the aperture unit 14 is adjusted based on a P-th depth of field set in the specific AF table.

In a step S115, resetting and starting a timer 26t by using a timer value as 50 milliseconds, and in a step S117, it is determined whether or not time-out has occurred in the timer 26t. When a determined result is updated from NO to YES, in a step S119, the variable P is incremented.

In a step S121, it is determined whether or not the variable P has exceed “3”, and when a determined result is NO, the process returns to the step S111, and when the determined result is YES, the process advances to a step S123.

In the step S123, the focus lens 12 is moved based on the target AF distance Le. In a step S125, the driver 18b is commanded to adjust the aperture amount of the aperture unit 14 so as to set the depth of field to “Db” which is the shallowest in the predetermined depths of field. Upon completion of the process in the step S125, the process returns to the routine in an upper hierarchy.

As can be seen from the above described explanation, the image sensor 16 captures the scene through the optical system. The CPU 26 adjusts the object distance to the designated distance, and adjusts the depth of field to the predetermined depth, corresponding to completion of the adjustment. The touch sensor 50 and the CPU 26 accept the changing operation for changing the length of the designated distance. Moreover, the CPU 26 changes the depth of field to the enlarged depth greater than the predetermined depth, in response to the changing operation.

In response to the operation for changing the designated magnitude of the object distance, the depth of field is changed to the enlarged depth greater than the predetermined depth. That is, the depth of field is set to the depth greater than before adjusting the object distance.

Accordingly, even when the object distance is drastically changed, it becomes possible to improve a quality of an image outputted from the imager by reducing the blur associated with changing the object distance.

It is noted that, in this embodiment, in the specific AF process, the target AF distance Le equivalent to the distance between the digital video camera 10 and the person of the updated main face image is calculated so as to change the AF distance to the target AF distance Le. However, the adjusting process may be executed after completion of the changing process so as to adjust the AF distance with high accuracy.

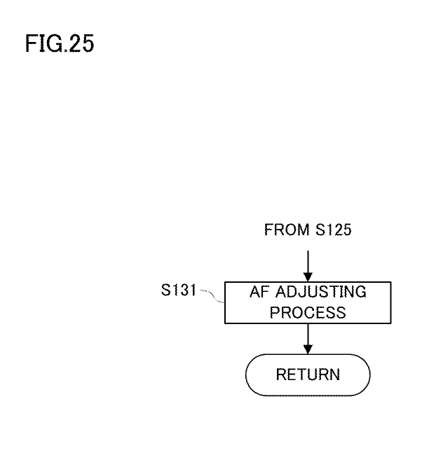

In this case, a process in a step S131 shown in FIG. 25 may be executed after completion of the process in the step S125 shown in FIG. 24 so as to return to the routine in an upper hierarchy upon completion of the process in the step S131.

In the step S131, an AF adjusting process is executed in a following manner. The CPU 26 extracts, out of the 256 AF evaluation values outputted from the AF evaluating circuit 24, AF evaluation values corresponding to the position and size registered in the main-face image register RGSTma. Moreover, the CPU 26 adjust the position of the focus lens 12 based on the extracted partial AF evaluation values.

Moreover, in this embodiment, changing the AF distance in four steps is executed in the specific AF process, however, the changing may be executed in other steps of more than two steps.

Moreover, in this embodiment, the aperture amount of the aperture unit 14 is adjusted so as to change the depth of field after completion of the AF process or changing the AF distance. However, the depth of field may be changed before completion of these processes or before starting these processes.

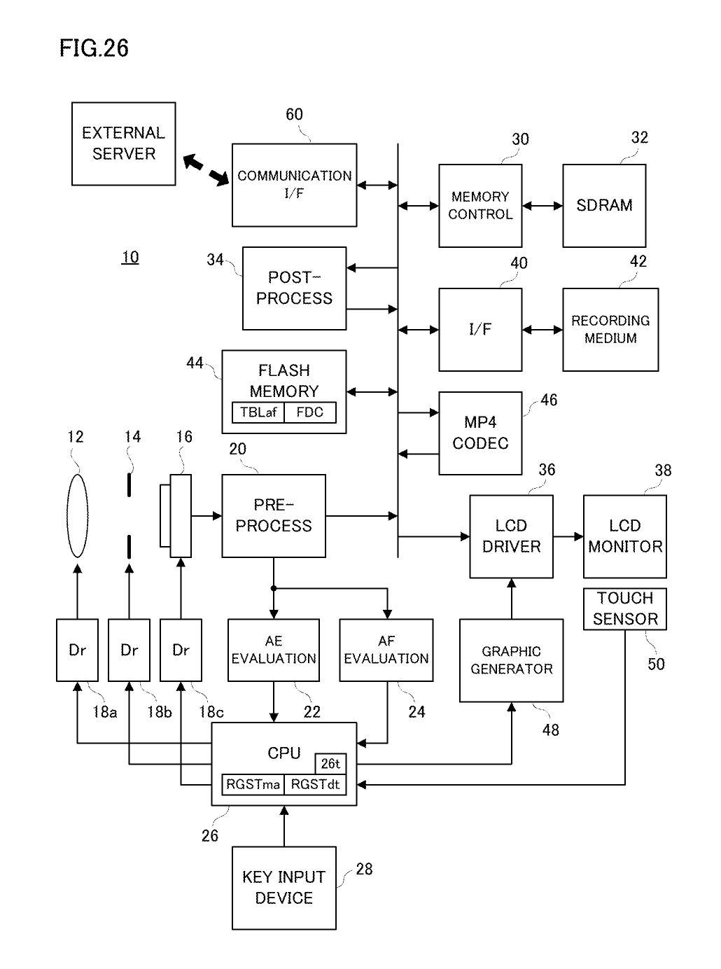

Moreover, in this embodiment, the control programs equivalent to the multi task operating system and the plurality of tasks executed thereby are previously stored in the flash memory 44. However, a communication I/F 60 may be arranged in the digital video camera 10 as shown in FIG. 26 so as to initially prepare a part of the control programs in the flash memory 44 as an internal control program whereas acquire another part of the control programs from an external server as an external control program. In this case, the above-described procedures are realized in cooperation with the internal control program and the external control program.

Moreover, in this embodiment, the processes executed by the CPU 26 are divided into a plurality of tasks including the imaging task shown in FIG. 17, the face detecting task shown in FIG. 18 and the AE/AF control task shown in FIG. 21 to FIG. 22. However, these tasks may be further divided into a plurality of small tasks, and furthermore, a part of the divided plurality of small tasks may be integrated into the main task. Moreover, when each of tasks is divided into the plurality of small tasks, the whole task or a part of the task may be acquired from the external server.

Moreover, in this embodiment, the present invention is explained by using a digital video camera, however, a digital still camera, cell phone units or a smartphone may be applied to.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera comprising:
an imager which captures a scene through an optical system;
a distance adjuster which adjusts an object distance to a designated distance;
a depth adjuster which adjusts a depth of field to a predetermined depth, corresponding to completion of an adjustment of said distance adjuster;
an acceptor which accepts a changing operation for changing a length of the designated distance; and
a changer which changes the depth of field to an enlarged depth greater than the predetermined depth, in response to the changing operation.

2. The electronic camera according to claim 1, further comprising a setter which sets a magnitude of the enlarged depth so as to be different depending on a difference between the object distance at a time point at which the changing operation is accepted and the distance designated by the changing operation.

3. The electronic camera according to claim 1, wherein said distance adjuster includes a first distance adjuster which adjusts, in response to the changing operation, the object distance to a distance between a current distance and the designated distance and a second distance adjuster which adjusts the object distance to the designated distance after the adjustment of said first distance adjuster, and said changer adjusts the magnitude of the enlarged depth so as to be different depending on a length of the object distance adjusted by said first distance adjuster.

4. The electronic camera according to claim 3, wherein said depth adjuster includes a predetermined depth adjuster which adjusts the depth of field to the predetermined depth in association with an adjusting process of said second distance adjuster.

5. The electronic camera according to claim 3, wherein said distance adjuster further includes a distance designator which designates each of a plurality of distances existing between the current distance and the designated distance as a distance noticed by said first distance adjuster, and said changer adjusts the magnitude of the enlarged depth at each designation of said distance designator.

6. The electronic camera according to claim 1, wherein the changing operation is equivalent to an operation designating a desired object existing in the scene, said electronic camera, further comprising a calculator which calculates a distance to the object designated by the changing operation, as the designated distance.

7. The electronic camera according to claim 6, wherein the object designated by the changing operation is equivalent to a face of a person, and said calculator executes a calculating process based on a size of an image representing the object designated by the changing operation.

8. The imaging control program recorded on a non-transitory recording medium in order to control an electronic camera provided with an imager which captures a scene through an optical system, the program causing a processor of the electronic camera to perform the steps comprising:
a distance adjusting step of adjusting an object distance to a designated distance;
a depth adjusting step of adjusting a depth of field to a predetermined depth, corresponding to completion of an adjustment of said distance adjusting step;
an accepting step of accepting a changing operation for changing a length of the designated distance; and
a changing step of changing the depth of field to an enlarged depth greater than the predetermined depth, in response to the changing operation.

9. The imaging control method executed by an electronic camera provided with an imager which captures a scene through an optical system, comprising:
a distance adjusting step of adjusting an object distance to a designated distance;
a depth adjusting step of adjusting a depth of field to a predetermined depth, corresponding to completion of an adjustment of said distance adjusting step;
an accepting step of accepting a changing operation for changing a length of the designated distance; and
a changing step of changing the depth of field to an enlarged depth greater than the predetermined depth, in response to the changing operation.
